(19) United States
(12) Patent Application Publication
(10) Pub. No.: US 2026/0288112 A1
(43) Pub. Date: Sep. 24, 2026

(54) PROCESS DATA PROCESSING DEVICE AND PROCESS PROCESSING METHOD

(71) Applicants: PSK INC., Gyeonggi-do (KR); RTM Inc., Seoul (KR)

(72) Inventors: Tae Kyung HA, Gyeonggi-do (KR); Sang Yeop KIM, Gyeonggi-do (KR); Yeon Mo KIM, Gyeonggi-do (KR)

(21) Appl. No.: 19/165,944

(22) PCT Filed: Mar. 15, 2024
(86) PCT No.: PCT/KR2024/003303

§ 371 Date: Sep. 16, 2025

(30) Foreign Application Priority Data
Mar. 17, 2023 (KR) 10-2023-0034996

(51) Int. Cl. G05B 19/4099

(52) U.S. Cl. CPC G05B 19/4099; G05B 2219/45031

(57) ABSTRACT

A process data processing device of the present disclosure includes: a sensor unit that detects physical magnitude values with respect to time during a process while the process is performed; a process data recording unit that, in conjunction with the sensor unit, receives physical magnitude values with respect to time every time a process schedule is performed, records the received physical magnitude values with respect to time as process data, and accumulatively records the process data for each process schedule; and an operation step in which an operation unit that selects at least any one item of optimal process data from the process data by a preset optimal process selection operation, and sets preset range value for the selected optimal process data as an upper threshold and a lower threshold of the process data; and

### TECHNICAL FIELD

The present disclosure relates to a process data processing device and a process processing method and, more specifically, to a process data processing device and a process processing method that process processing data input from various sensors.

### BACKGROUND ART

In the semiconductor manufacturing process, various sensors are installed, process data is input, and the semiconductor process is monitored and controlled on the basis of the input process data.

Such process data is input from respective sensors for temperature, pressure, voltage, current, electromagnetic field, and distance, and impulses and noise are mixed in such process data, and such impulses and noise generate frequent warning alarms to the worker, thereby causing fatigue.

When frequent warning alarms are generated due to such noise, for example, as illustrated in FIG. 1, assuming that process data on pressure versus time in a process chamber during a semiconductor manufacturing process is provided, no warning alarm is generated in a process segment 1a in which the pressure inside the chamber remains almost unchanged.

However, in a process segment 1b in which noise or an impulse is momentarily generated, such as when gas is injected into the process chamber or when a power supply for generating plasma is turned on, a large input value is momentarily input together with noise, so the internal pressure value significantly fluctuates.

In this case, in a segment in which pressure increases above a predetermined value, a system that monitors pressure generates a warning alarm, and since such warning alarms is generated during every process, they cause significant fatigue to workers. In particular, workers who hear frequent warning alarms tend to distrust and ignore the warning alarms, which causes a problem that no follow-up action is taken even when an actual problem occurs.

However, since there is no standard procedure for setting an upper threshold and a lower threshold for generating warning alarms on process data, the thresholds are set by relying on the knowledge of workers rather than being determined on the basis of the process data, and this causes qualitative differences in statistical process control techniques depending on whether workers are skilled or unskilled, thereby making it impossible to manage a system in a stable and uniform manner.

In addition, the work of setting an upper threshold and a lower threshold for warning alarms for process data has to be carried out through consultation so that all workers managing the process can be aware of them and so that the agreement of all can be ensured.

Accordingly, after setting an upper threshold and a lower threshold of process data through consultation, in order not to repeat a cumbersome consultation process, the upper threshold and the lower threshold for warning alarms are set at excessively broad ranges. In this way, since an upper threshold and a lower threshold of process data are set at excessively broad ranges, it frequently occurs that warning alarms having actual significance are ignored.

Furthermore, even if an upper threshold and a lower threshold of process data are set through consultation, in a process segment 1b, where noise or impulse is momentarily generated and large fluctuations occur, such as when gas is injected into a chamber or when a power supply for generating plasma is turned on as described above, meaningful upper threshold and lower threshold for warning alarms cannot be set on the process data, so that a corresponding technical solution is required.

### DISCLOSURE

### Technical Problem

An objective of the present disclosure for solving the above-described problems is to provide a process data processing device and a process processing method capable of uniformly setting an upper threshold and a lower threshold even without direct adjustment of the process data by workers.

Further, another objective of the present disclosure is to provide a process data processing device and a process processing method capable of setting meaningful upper threshold and lower threshold even in a segment where impulse, like noise, causes momentary variations.

The problem to be solved by the present invention is not limited to the above-mentioned problems, and the problems not mentioned will be clearly understood by those skilled in the art from the present specification and the accompanying drawings.

### Technical Solution

In order to achieve the objectives of the present disclosure described above, a process data processing device includes: a sensor unit that detects physical magnitude values with respect to time during a process while the process is performed; a process data recording unit that, in conjunction with the sensor unit, receives physical magnitude values with respect to time every time a process schedule is performed, records the received physical magnitude values with respect to time as process data, and accumulatively records the process data for each process schedule; and an operation step in which an operation unit that selects at least any one item of optimal process data from the process data by a preset optimal process selection operation, and sets preset range value for the selected optimal process data as an upper threshold and a lower threshold of the process data.

According to the exemplary embodiment, the upper threshold and the lower threshold may be include, in terms of classification based on variations in the physical magnitude value with respect to time, a large-variation upper/lower range 7b in which the physical magnitude value with respect to time varies greatly due to a sudden change such as pulse or noise.

According to the exemplary embodiment, when performing the optimal process selection operation, the operation unit may be performs an operation on the process data each of segments.

According to the exemplary embodiment, when the operation unit performs the optimal process selection operation, the segments may be classified on the basis of whether differentiated data generated by differentiating the process data exceeds a preset reference value or does not exceed the preset reference value.

According to the exemplary embodiment, when performing the optimal process selection operation, the operation unit may extract feature information performing time-series processing on the process data for each of the segments.

According to the exemplary embodiment, the feature information may be extracted for each of the segments, including a start time, an end time, a duration, a start value, an end value, a minimum value, and a maximum value.

According to the exemplary embodiment, the feature information may be extracted for each of the segments, further including at least any one of a range, a mean, an autocorrelation, a standard deviation, a slope, a coefficient of determination, a kurtosis, a concavity, a convexity, a skewness, and a crossing ratio.

According to the exemplary embodiment, when performing the optimal process selection operation, the operation unit may generate cluster group data by clustering the feature information of the process data, and extracts at least any one cluster within a predetermined range from a cluster center of the generated cluster group data as an optimal process.

According to the exemplary embodiment, when generating the cluster group data, the operation unit may generate a plurality of items of cluster group data and select the number of clusters in the plurality of items of cluster group data.

According to the exemplary embodiment, when selecting the number of clusters of the plurality of items of cluster group data, the operation unit may perform the selection using any one of a silhouette method, an elbow method, or a prior information classification method.

According to the exemplary embodiment, the operation unit may extract the optimal process using any one of a K-Means model, a Gaussian Mixture Model (GMM), and an Agglomerative Hierarchical Clustering model.

According to the exemplary embodiment, the upper threshold and the lower threshold of the process data may be set by applying an upper/lower ratio or an upper/lower deviation to one item of process data associated with the optimal process, or to an average value of a plurality of items of process data extracted as optimal processes, or may be set as an average of maximum values and an average of minimum values of the plurality of items of process data extracted as optimal processes.

A process processing method comprising: a process data recording step in which a process data recording unit that, in conjunction with the sensor unit, receives physical magnitude values with respect to time every time a process schedule may be performed, records the received physical magnitude values with respect to time as process data, and accumulatively records the process data for each process schedule; an operation step in which an operation unit that selects at least any one item of optimal process data from the process data by a preset optimal process selection operation, and sets preset range value for the selected optimal process data as an upper threshold and a lower threshold of the process data; and a threshold monitoring step in which a threshold monitoring unit generates a warning alarm when a physical magnitude value with respect to time detected by the sensor unit deviates from the upper threshold and the lower threshold.

According to the exemplary embodiment, in the operation step, the upper threshold and the lower threshold may include, in terms of classification based on variations in the physical magnitude value with respect to time, a large-variation upper/lower range 7b in which the physical magnitude value with respect to time varies greatly due to a sudden change such as pulse or noise.

According to the exemplary embodiment, in the operation step, when performing the optimal process selection operation, the operation unit may perform an operation on the process data each of segments.

According to the exemplary embodiment, in the operation step, when the operation unit may perform the optimal process selection operation, the segments may be classified on the basis of whether differentiated data generated by differentiating the process data exceeds a preset reference value or does not exceed the preset reference value.

According to the exemplary embodiment, in the operation step, when performing the optimal process selection operation, the operation unit may extract feature information performing time-series processing on the process data for each of the segments.

According to the exemplary embodiment, the feature information may be extracted for each of the segments, including a start time, an end time, a duration, a start value, an end value, a minimum value, and a maximum value.

According to the exemplary embodiment, the feature information may be extracted for each of the segments, further including at least any one of a range, a mean, an autocorrelation, a standard deviation, a slope, a coefficient of determination, a kurtosis, a concavity, a convexity, a skewness, and a crossing ratio.

According to the exemplary embodiment, in the operation step, when performing the optimal process selection operation, the operation unit may generate cluster group data by clustering the feature information of the process data, and extract at least any one cluster within a predetermined range from a cluster center of the generated cluster group data as an optimal process.

According to the exemplary embodiment, in the operation step, when generating the cluster group data, the operation unit may generate a plurality of items of cluster group data and select the number of clusters in the plurality of items of cluster group data.

According to the exemplary embodiment, in the operation step, when selecting the number of clusters of the plurality of items of cluster group data, the operation unit may perform the selection using any one of a silhouette method, an elbow method, or a prior information classification method.

According to the exemplary embodiment, in the operation step, the operation unit may extract the optimal process using any one of a K-Means model, a Gaussian Mixture Model (GMM), and an Agglomerative Hierarchical Clustering model.

According to the exemplary embodiment, in the operation step, when the upper threshold and the lower threshold of the process data may be set, the upper threshold and the lower threshold of the process data may be set by applying an upper/lower ratio or an upper/lower deviation to one item of process data associated with the optimal process, or to an average value of a plurality of items of process data extracted as optimal processes, or may be set as an average of maximum values and an average of minimum values of the plurality of items of process data extracted as optimal processes.

### Advantageous Effects

The present disclosure has the effect that, since an upper threshold and a lower threshold are set on the basis of process data generated in a process without a worker directly setting the upper threshold and the lower threshold, the upper threshold and the lower threshold can be set uniformly and stably.

Further, the present disclosure has the effect that when setting an upper threshold and a lower threshold of process data, it is possible to determine the process data uniformly and stably even in a large-variation upper/lower range 7b, in which a physical magnitude value varies greatly with respect to time due to a sudden change such as pulse or noise, in terms of classification based on variations in the physical magnitude value with respect to time.

The effect of the present invention is not limited to the foregoing effects, and the not-mentioned effects will be clearly understood by those skilled in the art from the present specification and the accompanying drawings.

### DESCRIPTION OF DRAWINGS

FIG. 1 is a graph of pressure values versus time during the execution of one process schedule.

FIG. 2 is a configuration diagram of a process data processing device according to an embodiment of the present disclosure.

FIG. 3 is a graph in which the process data processing device illustrated in FIG. 2 represents physical magnitude values of pressure versus time in a process chamber as process data and shows the process data in a differentiated state.

FIG. 4 is a table listing respective items of feature information extracted by an operation unit.

FIG. 5 is a dimensional graph illustrating a clustering state based on feature information extracted by the operation unit for each segment.

FIG. 6 is a graph of silhouette values for respective cluster group data when the operation unit executes a silhouette method.

FIG. 7 is a graph of result values when the operation unit performs an elbow method.

FIG. 8 is a graph representing centers in respective cluster group data.

FIG. 9 is a graph in which process data for respective cluster group data selected as optimal processes are illustrated together on one graph.

FIG. 10 is a graph illustrating an upper threshold and a lower threshold of process data.

FIG. 11 is a flowchart of a process processing method using the process data processing device according to an embodiment of the present disclosure.

FIGS. 12 and 13 are graphs illustrating a state of monitoring whether process data obtained by performing a process in accordance with a process schedule deviates from an upper threshold and a lower threshold stored in a threshold monitoring unit.

### BEST MODE

Hereinafter, embodiments for implementing the present disclosure will be described with reference to the accompanying drawings, and in this case, throughout the specification, when any portion is described as “including” a component, it is to be construed, unless expressly stated otherwise, as not excluding the presence of other components but allowing the inclusion of additional components. In addition, the term “ . . . unit” described in the specification is construed, in the case of electronic hardware or electronic software, as a unit that processes at least one function or operation, and, in the case of a mechanical apparatus, as meaning one part, function, use, point, or driving element. In addition, hereinafter, the same reference numerals will be used to describe the same or similar configurations, and redundant descriptions of identical components will be omitted.

In addition, when an element or a layer is referred to in the present disclosure as being “on,” “connected to,” “coupled to,” “attached to,” “adjacent to,” or “covering” another element or layer, it may be directly on, connected to, coupled to, attached to, adjacent to, or covering the other element or layer, or intervening elements or layers may be present. In contrast, when an element is referred to as being “directly on,” “directly connected to,” or “directly coupled to” another element or layer, it is to be understood that no intervening elements or layers are present. Throughout the specification, the same reference numerals refer to the same elements. The term “and/or” used in the present disclosure includes all combinations and sub-combinations of one or more of the listed items.

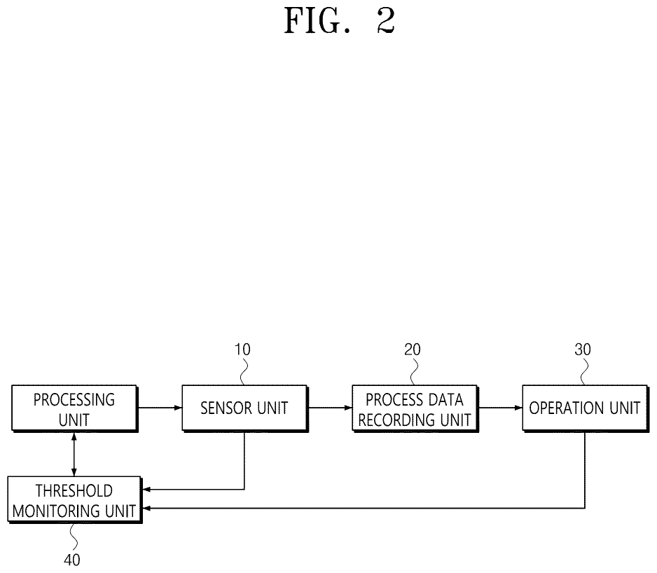

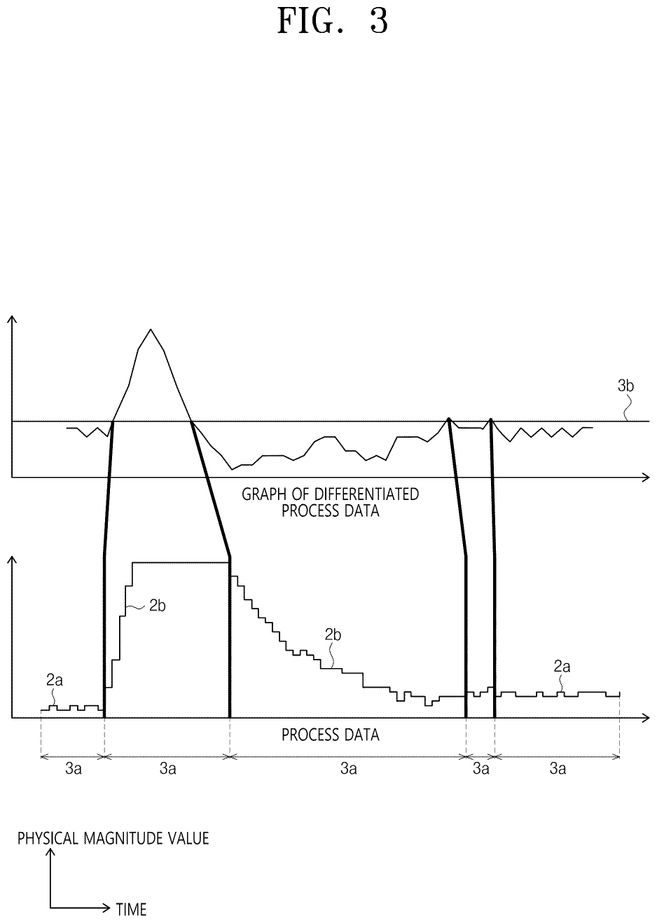

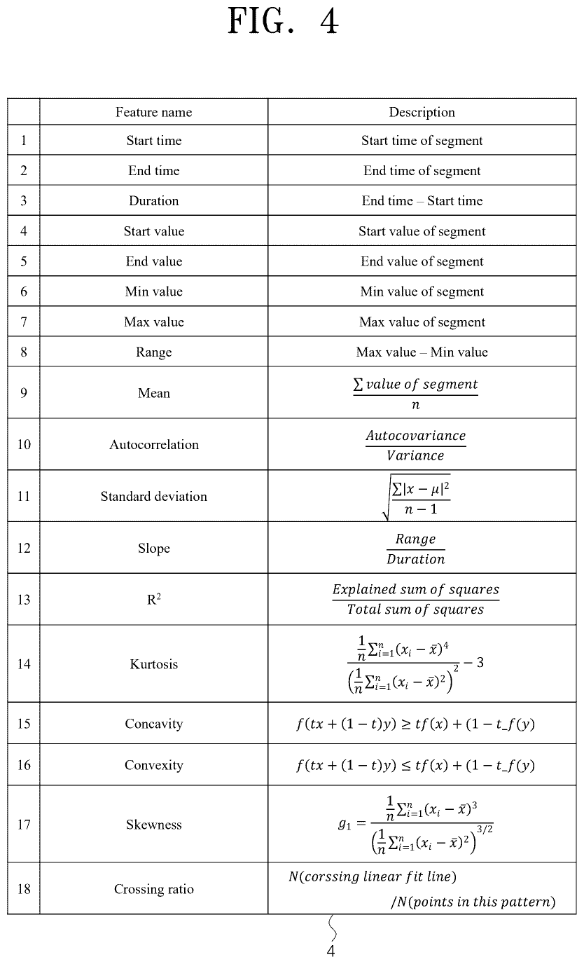

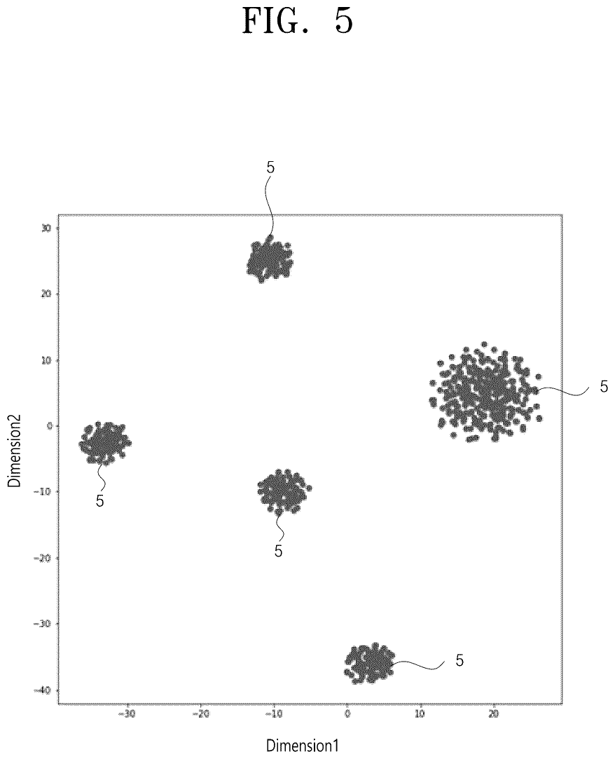

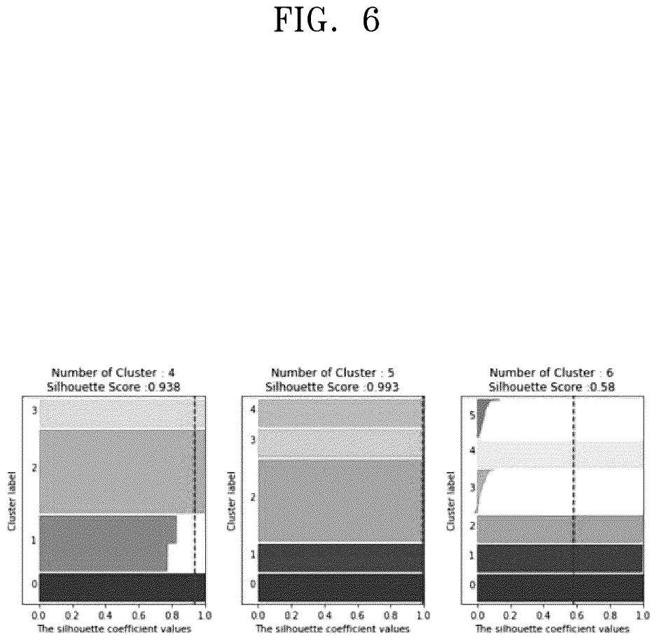

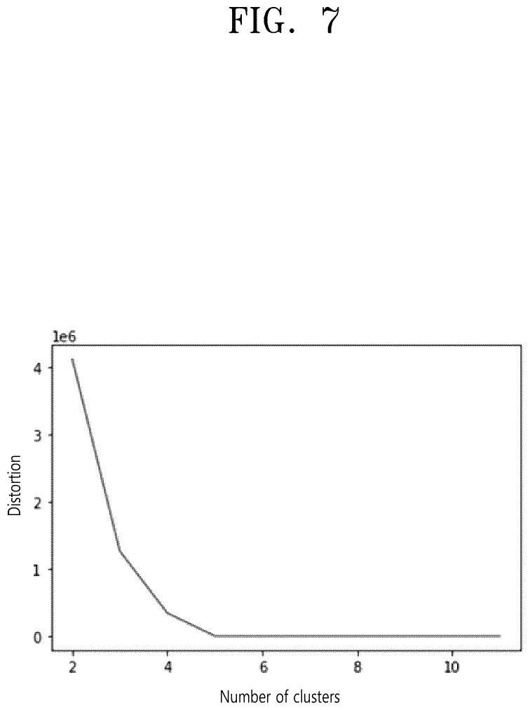

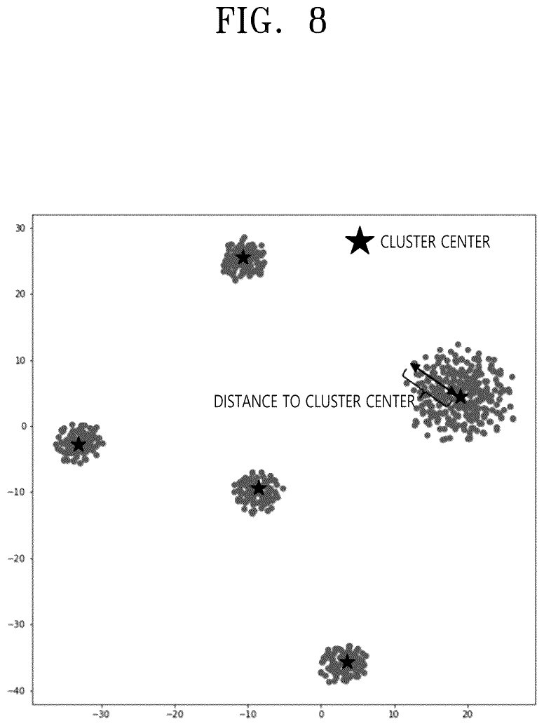

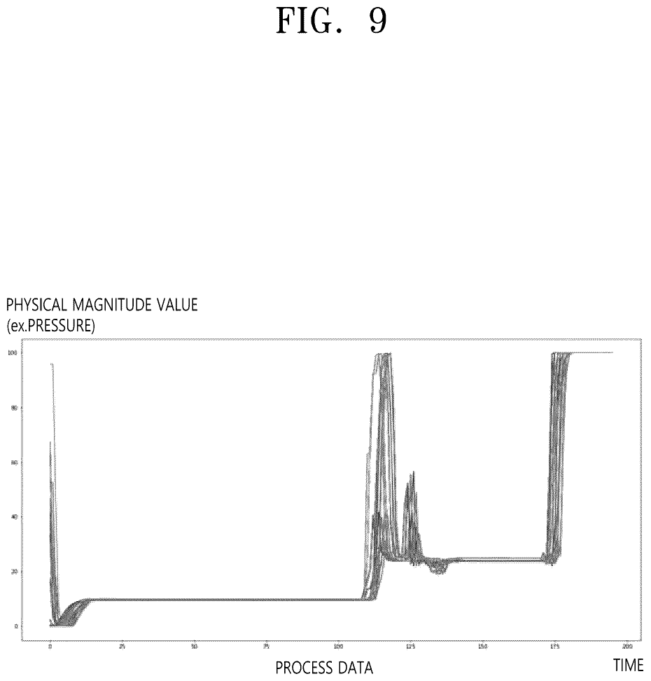

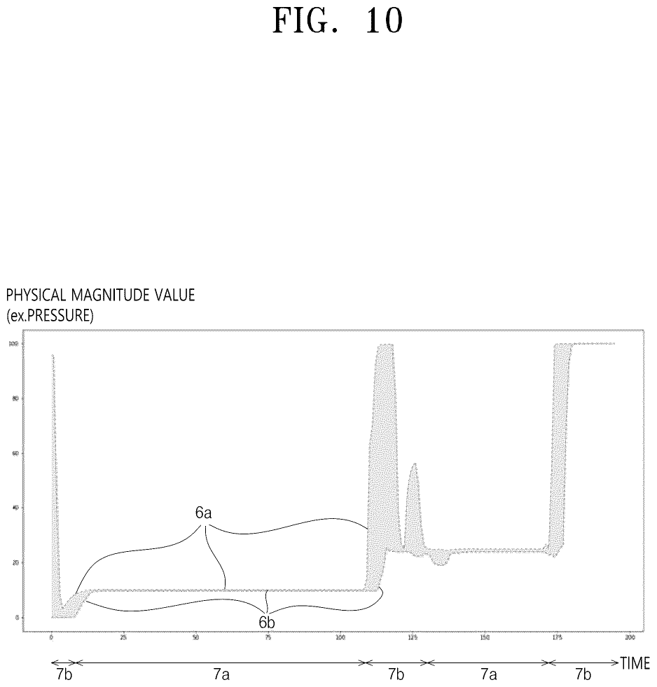

FIG. 2 is a configuration diagram of a process data processing device according to an embodiment of the present disclosure. FIG. 3 is a graph in which the process data processing device illustrated in FIG. 2 represents physical magnitude values of pressure versus time in a process chamber as process data and shows the process data in a differentiated state. FIG. 4 is a table listing respective items of feature information extracted by an operation unit. FIG. 5 is a dimensional graph illustrating a clustering state based on feature information extracted by the operation unit for each segment. FIG. 6 is a graph of silhouette values for respective cluster group data when the operation unit executes a silhouette method. FIG. 7 is a graph of result values when the operation unit performs an elbow method. FIG. 8 is a graph representing centers in respective cluster group data. FIG. 9 is a graph in which process data for respective cluster group data selected as optimal processes are illustrated together on one graph. FIG. 10 is a graph illustrating an upper threshold and a lower threshold of process data.

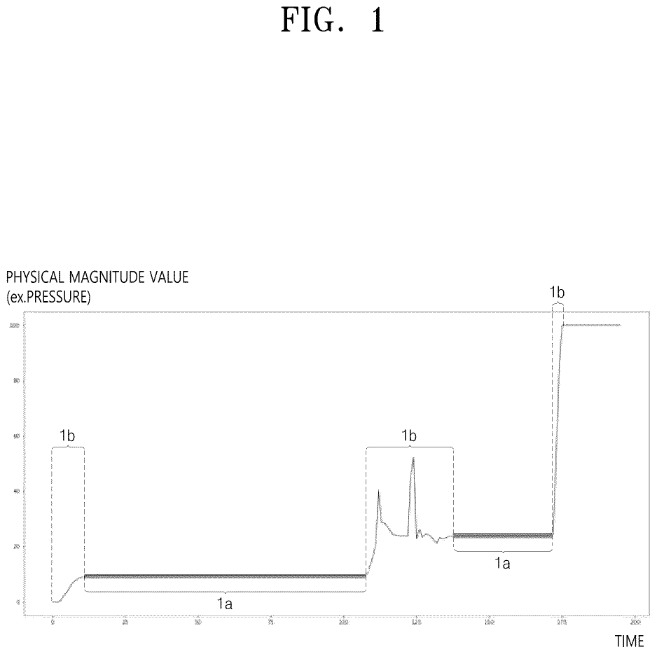

As illustrated in FIGS. 1 to 10, a process data processing device according to an embodiment of the present disclosure includes a sensor unit 10, a process data recording unit 20, and an operation unit 30.

The sensor unit 10 is a device that detects physical magnitude values with respect to time during a process while a processing unit performs the process. Here, the process corresponds to all processes such as an oxidation process, a photo process, an exposure process, a heating process, a photoresist removal process, a physical etching process, a chemical etching process, a cleaning process, a deposition process, and a packaging process for processing a substrate such as a wafer, and further may include all processes related to transfer and storage of a substrate. The sensor unit 10 used in such processes can detect physical magnitude values such as temperature, humidity, density, voltage, current, power, pressure, displacement, angle, and light quantity, and can generate an analog signal or digital signal value corresponding to the magnitude. For example, as for the sensor unit 10, the sensor unit 10 may be configured by selectively using a thermistor, an RTD sensor, a potential sensor, a humidity sensor, an eddy current sensor, a CMOS sensor, a photodiode, a strain gauge, a piezoelectric sensor, a LiDAR sensor, or a laser sensor, and may further include a signal converter for converting signals of these sensors into analog or digital signals. As described above, since the sensor unit 10 can be variously modified and implemented, in this embodiment, for convenience of explanation, the sensor unit 10 is exemplified as including a pressure sensor that measures pressure in a process chamber and a signal converter that converts a signal value detected by the pressure sensor into a digital signal. Accordingly, when the sensor unit 10 measures pressure in a process chamber, as illustrated in FIG. 3, process data is obtained in the form of physical magnitude values of pressure versus time.

The process data recording unit 20 is an input/output operation device such as a PC, ROM, PLC, or programmable logic. Such a process data recording unit 20, in conjunction with the sensor unit 10, receives physical magnitude values with respect to time every time a process schedule is performed, records the received physical magnitude values with respect to time as process data, and accumulatively records the process data for each process schedule. For example, as illustrated in FIG. 3, the process data recording unit 20 records process data for one process schedule, and records process data for each process schedule through a process of recording new process data in a form similar to that of FIG. 3 when the next process schedule is performed. In this case, as illustrated in FIG. 3, the process data, when classified on the basis of variations in physical magnitude values with respect to time, may include a small-variation region 2a in which the physical magnitude values do not significantly vary with respect to time, and a large-variation region 2b in which the physical magnitude values significantly vary with respect to time.

The operation unit 30 is an input/output operation device such as a PC, ROM, PLC, or programmable logic. In this case, the operation unit 30 may be configured in conjunction with the process data recording unit 20 in a single input/output processing device, or may be configured in conjunction as a separate unit.

The operation unit 30 selects at least any one item of optimal process data from the process data by a preset optimal process selection operation, and sets preset range values for the selected optimal process data as an upper threshold 6a and a lower threshold 6b of the process data.

More specifically, for example of the operation unit 30 performing an optimal process selection operation, first, when the operation unit 30 performs an optimal process selection operation, the operation unit 30 divides the process data by segments 3a and performs operations. Here, the reason for dividing and calculating the process data by segments 3a is to prevent the characteristics of data for respective sub-schedules from being mixed with one another during data analysis of a plurality of sub-schedules performed in one process schedule. Here, for example of the sub-schedules, the sub-schedules include a process in which, when process data regarding pressure is generated by performing a process in a process chamber, process gas is injected and accordingly the pressure inside the process chamber rapidly changes, a process in which a process is performed while the pressure inside the process chamber is maintained at a constant level, and a process in which the process gas is discharged and accordingly the pressure inside the process chamber is reduced.

In this case, the criterion for the operation unit 30 to divide the process data by segments 3a may be set to respective preset times on the process schedule.

Further, the criterion for the operation unit 30 to divide the process data by segments 3a may, as illustrated in FIG. 3, be based on whether differentiated data generated by differentiating the process data by the operation unit 30 exceeds a preset reference value 3b or does not exceed the preset reference value 3b. In this way, when one process schedule is performed, process data is divided by segments 3a corresponding to respective sub-schedules in the process schedule, whereby it is possible to prevent sub-schedules of different segments 3a from being mixed during data analysis. The process data illustrated in FIG. 3 is depicted with moderate variations in the process data in order to facilitate understanding of the process of forming differentiated data, whereas the graphs of process data illustrated in subsequent examples will be depicted with larger variations in the process data for explanation.

Further, as described above, after dividing the process data by segments 3a, the operation unit 30 extracts feature information 4 by performing time-series processing for each segment 3a. Here, the feature information 4 may be used for comparison among the segments 3a, for scoring by applying a predictive model to each segment 3a, or for detection information on whether there is an anomaly in each segment 3a.

As an example of the feature information 4, as illustrated in FIG. 4, the feature information 4 may be extracted for each segment 3a of the process data, including a start time, an end time, a duration, a start value, an end value, a minimum value, and a maximum value. Further, the feature information 4 may be formed by extracting, for each segment 3a, at least any one of a range, a mean, an autocorrelation, a standard deviation, a slope, a coefficient of determination (R²), a kurtosis, a concavity, a convexity, a skewness, and a crossing ratio on the basis of the extracted values described above. Accordingly, as described above, the operation unit 30 extracts a total of 18 items of feature information 4 for each segment 3a, and may can the extracted feature information 4 to compare among the segments 3a, to perform scoring by applying a predictive model to each segment 3a, or to detect whether there is an anomaly in each segment 3a.

Further, after extracting the feature information 4 for each segment 3a as described above, the operation unit 30 clusters the feature information 4 of the process data, as illustrated in FIG. 5, whereby clusters in the form of points are grouped and cluster group data 5 is generated. In this embodiment, five items of cluster group data 5 may be generated for each segment 3a.

Here, the reason why the operation unit 30 clusters the feature information 4 of the process data is that, even if the process data is extracted by the same sensor unit 10, different forms of process data are frequently generated due to environmental changes, recipe changes, or variations in the equipment itself. In this way, even if different forms of process data all belong to a normal category, normal process data may be regarded as defective data due to differences in their forms. Accordingly, the operation unit 30 performs clustering to determine whether each of the process data, even if having different forms from one another, is within an upper threshold 6a and a lower threshold 6b that constitute a normal category.

Accordingly, in order to perform clustering, the operation unit 30 generates a plurality of items of cluster group data 5, as illustrated in FIG. 5, and selects the number of clusters within the plurality of items of cluster group data 5 so that only clusters close to an optimal process are set.

Here, in order to determine the number of clusters within the plurality of items of cluster group data 5, the operation unit 30 can use any one of a silhouette method, an elbow method, or a prior information classification method.

First, when the operation unit 30 uses the silhouette method, the silhouette method is performed by the operation unit 30 calculating the number of clusters using Equation (1) below, and, as illustrated in FIG. 6, different silhouette scores are derived as result values, and among them, five clusters with the highest silhouette score are set as a reliable number of clusters.

$${s}^{( i )} = \frac{{b}^{( i )} - {a}^{( i )}}{max \{ {a}^{( i )} , {b}^{( i )} \}} , \qquad Equation ( 1 )$$

(a⁽ⁱ⁾ and b⁽ⁱ⁾ are average distances of data points i within clusters a and b, respectively, and S⁽ⁱ⁾ is silhouette coefficient of data point i).

Next, when the operation unit 30 uses the elbow method, the elbow method is a method in which the operation unit 30 squares and sums errors, that is, differences in distance between samples belonging to a specific cluster and the center of the cluster group data 5, and then designates as the number of clusters a point where improvement of the value is not significant when the number of clusters is increased. Here, the criterion for the degree to which the improvement is not significant means that the sum of squared errors decreases. When the operation unit 30 performs the elbow method in this manner, as illustrated in FIG. 7, it can be confirmed that the decrease in the sum of squared errors becomes smaller until the number of clusters becomes five, and that when the number of clusters reaches six, the decrease in the sum of squared errors is almost negligible. Accordingly, by setting five, which is the segment 3a where the decrease in the sum of squared errors becomes gradual, as the number of clusters, the number of clusters of the cluster group data 5 can be optimally selected.

Next, when the operation unit 30 uses a prior information classification method, the prior information classification method sets the number of clusters with reference to the number of clusters previously used or the number of clusters preset by related engineers.

When the number of clusters within the cluster group data 5 is determined by selecting such methods, the operation unit 30 performs clustering, and in this case, clustering is performed using any one of a K-means model, a Gaussian Mixture Model (GMM), or an Agglomerative Hierarchical Clustering model, whereby an optimal process is extracted.

Here, in order to extract an optimal process, the operation unit 30, as illustrated in FIG. 8, extracts the cluster group data 5 within a predetermined range from the cluster center of the generated cluster group data 5 as an optimal process. Here, the cluster center of the cluster group data 5 may be calculated by averaging the coordinates on a plane of the clusters constituting the cluster group data 5. At the center of the cluster group data 5, clusters having the most frequently occurring patterns are generally densely concentrated. That is, since the closer the cluster group data 5 is to the center, the more it corresponds to a stable process, it can be selected as an optimal process. In this case, when the center of the clustering data is selected as an optimal process, the cluster group data 5 within a predetermined ratio range of the distance from the center, for example, 5%, is extracted as an optimal process, whereby it is possible to select the most reliable optimal process.

In this way, the operation unit 30 that has selected optimal processes sets an upper threshold 6a and a lower threshold 6b on the basis of clusters corresponding to the optimal processes. In this case, the upper threshold 6a and the lower threshold 6b calculated by the operation unit 30 may, in terms of classification based on variations in the physical magnitude value with respect to time, include a small-variation upper/lower range 7a, in which the physical magnitude value with respect to time does not significantly vary, and a large-variation upper/lower range 7b, in which the physical magnitude value with respect to time varies greatly due to a sudden change such as pulse or noise.

In this case, when setting the upper threshold 6a and the lower threshold 6b, the operation unit 30 can set them by applying an upper/lower ratio or an upper/lower deviation to one item of process data associated with an optimal process, or to an average value of a plurality of items of process data extracted as optimal processes, or can set them as an average of maximum values and an average of minimum values of the plurality of items of process data extracted as optimal processes.

For example, the operation unit 30, having selected optimal processes, can select as an optimal process the process data associated with the one closest to the center of the cluster group data 5, and can set an upper threshold 6a and a lower threshold 6b by applying an upper/lower percentage rate or an upper/lower deviation to the selected process data.

In another example, the operation unit 30 can calculate average values for respective ones of a plurality of items of process data associated with an optimal process and select process data associated with the optimal process, and, as illustrated in FIG. 9, can set, in a state in which the plurality of items of process data selected as optimal processes are superimposed in terms of physical magnitude value with respect time, the process data that most frequently exhibits a maximum value as the upper threshold 6a and the process data that most frequently exhibits a minimum value as the lower threshold 6b. Alternatively, as illustrated in FIG. 9, the operation unit 30 can calculate an average of a plurality of items of process data associated with an optimal process, and can set the upper threshold 6a and the lower threshold 6b by determining upper and lower standard deviations with respect to the average.

The upper threshold 6a and the lower threshold 6b calculated in this way by the operation unit 30 are transmitted to a threshold monitoring unit 40 that monitors physical magnitude values in conjunction with the sensor unit 10, and the threshold monitoring unit 40 generates a warning alarm indicating that an issue has occurred in the process processing device when process data regarding physical magnitude values with respect to time, measured by the sensor unit 10, deviates from the upper threshold 6a and the lower threshold 6b.

Hereinafter, a process processing method using the process data processing device described above is described.

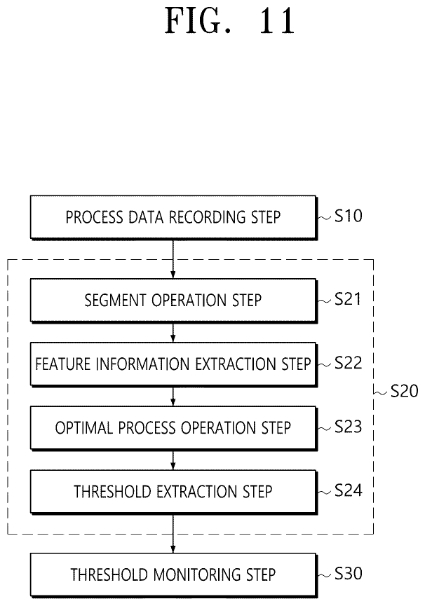

FIG. 11 is a flowchart of a process processing method using the process data processing device according to an embodiment of the present disclosure.

Referring further to FIG. 11, a process processing method according to an embodiment of the present disclosure includes a process data recording step (S10), an operation step (S20), and a threshold monitoring step (S30).

In the process data recording step (S10), the process data recording unit 20, in conjunction with the sensor unit 10, receives physical magnitude values with respect to time every time a process schedule is performed, records the received physical magnitude values with respect to time as process data, and accumulatively records the process data for each process schedule.

Next, the operation step (S20) includes a segment operation step (S21), a feature information extraction step (S22), an optimal process operation step (S23), and a threshold extraction step (S24).

First, in the segment operation step (S21), as described above, the operation unit 30 performs an operation on the process data separately by segments 3a. In this case, the method of distinguishing the segments 3a may be, as described above, based on predetermined time points in a process schedule of the process data at which a physical magnitude value changes or a process in the schedule changes, or, as illustrated in FIG. 3, may be based on whether differentiated data generated by differentiating the process data exceeds a preset reference value or does not exceed the preset reference value.

Next, in the feature information extraction step (S22), when performing an optimal process selection operation, the operation unit 30 extracts feature information 4 by performing time-series processing of the process data for each segment 3a. In this case, as described above with reference to FIG. 4, the feature information 4 may be extracted as a total of 18 items of data.

Next, in the optimal process operation step (S23), the operation unit 30 generates cluster group data 5 by clustering the feature information 4 of the process data, as illustrated in FIG. 5, and extracts the cluster group data 5 within a predetermined range from the cluster center of the generated cluster group data 5 as an optimal process.

In this case, in the optimal process operation step (S23), the operation unit 30 can generate a plurality of items of cluster group data 5 to extract clusters within the cluster group data 5 as optimal processes, select the number of clusters among the plurality of items of cluster group data 5 so that they can be used as optimal processes, and extract optimal processes from clusters within a predetermined range from the center of the cluster group data 5 by executing the selected clusters.

In this case, in the optimal process operation step (S23), as described above, when selecting the number of clusters of the plurality of items of cluster group data 5, the operation unit 30 can select the number of clusters using any one of a silhouette method, an elbow method, or a prior information classification method, and can extract an optimal process using any one of a K-means model, a Gaussian Mixture Model (GMM), or an Agglomerative Hierarchical Clustering model.

Next, in the threshold extraction step (S24), as illustrated in FIG. 10, an upper threshold 6a and a lower threshold 6b of the process data are set. For this purpose, in the threshold extraction step (S24), process data associated with at least any one optimal process extracted in the optimal process operation step (S23) may be used or a plurality of items of process data associated with clusters within a predetermined range from the cluster center may be used. Further, as described above, the thresholds can be applying an upper/lower ratio or an upper/lower deviation to one item of process data associated with an optimal process, or to an average value of a plurality of items of process data extracted as optimal processes, or can be set as an average of maximum values and an average of minimum values of the plurality of items of process data extracted as optimal processes.

Next, in the threshold monitoring step (S30), the threshold monitoring unit 40, in conjunction with the sensor unit 10, receives a physical magnitude value with respect to time, and generates a warning alarm when the physical magnitude value with respect to time, detected by the sensor unit 10, deviates from the upper threshold 6a and the lower threshold 6b. Here, the threshold monitoring unit 40 may be configured as an input/output operation device such as a PC, ROM, PLC, or programmable logic.

In the threshold monitoring step (S30), the threshold monitoring unit 40 operates in conjunction with the process processing device that performs a process, and monitors an upper threshold 6a and a lower threshold 6b of process data associated with an optimal process, received from the operation unit 30.

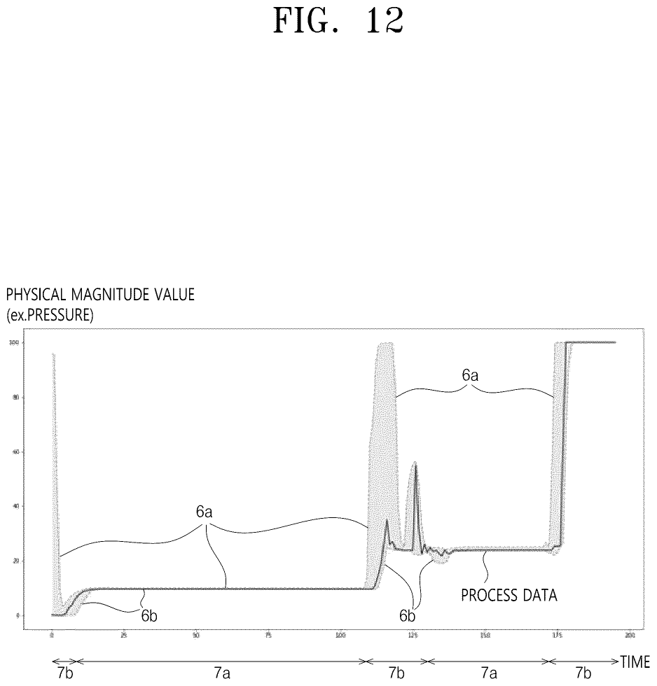

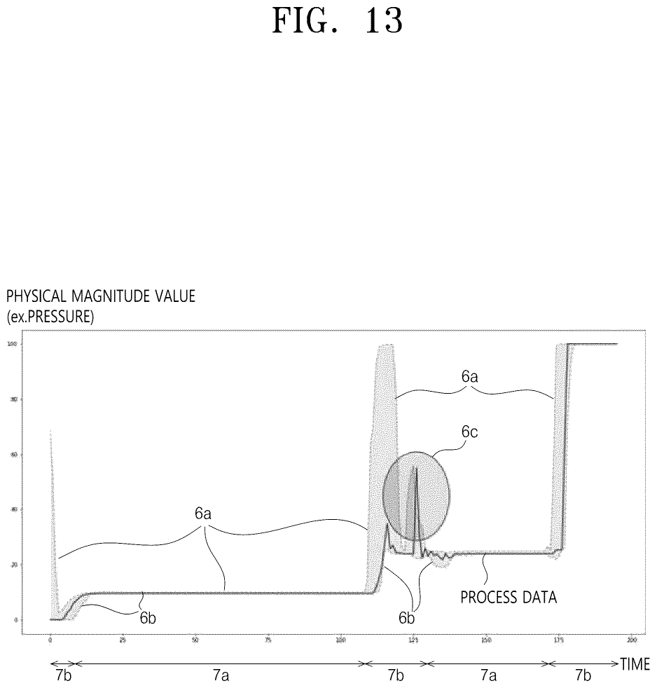

In more detail, referring further to FIGS. 12 and 13, FIGS. 12 and 13 are graphs illustrating a state of monitoring whether process data obtained by performing a process according to a process schedule deviates from an upper threshold 6a and a lower threshold 6b stored in the threshold monitoring unit 40.

As illustrated in FIG. 12, in the threshold monitoring step (S30), the threshold monitoring unit 40 monitors whether process data exceeds the upper threshold 6a and the lower threshold 6b while continuously recording the process data input through the sensor unit 10. In the threshold monitoring step (S30), the threshold monitoring unit 40 monitors the process data in this way, and does not generate a warning alarm when the process data does not deviate from the upper threshold 6a and the lower threshold 6b.

On the other hand, as illustrated in FIG. 13, in the threshold monitoring step (S30), the threshold monitoring unit 40 monitors process data, and generates a warning alarm when the process data deviates from the upper threshold 6a and the lower threshold 6b, as shown in 6c. Then, a worker checks the warning alarm and determines what issue in the process has caused the warning alarm to be generated.

Therefore, according to the process data processing device and the process processing method according to an embodiment of the present disclosure, since an upper threshold 6a and a lower threshold 6b are set on the basis of process data generated in the process without a worker directly setting the upper threshold 6a and the lower threshold 6b, the upper threshold 6a and the lower threshold 6b can be set uniformly and stably. Therefore, the process data processing device and the process processing method according to an embodiment of the present disclosure allow only warning alarms related to actual issues to be generated, thereby reducing worker's fatigue and improve the reliability of the warning alarms.

In addition, according to the process data processing device and the process processing method according to according to an embodiment of the present disclosure, when setting an upper threshold 6a and a lower threshold 6b of process data, it is possible to determine the process data uniformly and stably even in a large-variation upper/lower range 7b, in which a physical magnitude value with respect to time varies greatly due to a sudden change such as pulse or noise, in terms of classification based on variations in the physical magnitude value with respect to time.

Hereinabove, although the present disclosure is described by specific matters such as concrete components, and the like, embodiments, and drawings, they are provided only for assisting in the entire understanding of the present invention. Therefore, the present disclosure is not limited to the embodiments and various modifications and changes may be made by those skilled in the art to which the present disclosure pertains from this description.

Therefore, the sprit of the present disclosure should not be limited to the above-described embodiments, and the following claims as well as all modified equally or equivalently to the claims are intended to fall within the scope and spirit of the present disclosure.

1. A process data processing device comprising:
a sensor unit that detects physical magnitude values with respect to time during a process while the process is performed;
a process data recording unit that, in conjunction with the sensor unit, receives physical magnitude values with respect to time every time a process schedule is performed, records the received physical magnitude values with respect to time as process data, and accumulatively records the process data for each process schedule; and
an operation unit that selects at least any one item of optimal process data from the process data by a preset optimal process selection operation, and sets preset range value for the selected optimal process data as an upper threshold and a lower threshold of the process data.

2. The process data processing device of claim 1, wherein the upper threshold and the lower threshold include, in terms of classification based on variations in the physical magnitude value with respect to time, a large-variation upper/lower range 7b in which the physical magnitude value with respect to time varies greatly due to a sudden change such as pulse or noise.

3. The process data processing device of claim 1, wherein when performing the optimal process selection operation, the operation unit performs an operation on the process data each of segments.

4. The process data processing device of claim 3, wherein when the operation unit performs the optimal process selection operation, the segments are classified on the basis of whether differentiated data generated by differentiating the process data exceeds a preset reference value or does not exceed the preset reference value.

5. The process data processing device of claim 3, wherein when performing the optimal process selection operation, the operation unit extracts feature information performing time-series processing on the process data for each of the segments.

6. The process data processing device of claim 5, wherein the feature information is extracted for each of the segments, including a start time, an end time, a duration, a start value, an end value, a minimum value, and a maximum value.

7. The process data processing device of claim 6, wherein the feature information is extracted for each of the segments, further including at least any one of a range, a mean, an autocorrelation, a standard deviation, a slope, a coefficient of determination, a kurtosis, a concavity, a convexity, a skewness, and a crossing ratio.

8. The process data processing device of claim 5, wherein when performing the optimal process selection operation, the operation unit generates cluster group data by clustering the feature information of the process data, and extracts at least any one cluster within a predetermined range from a cluster center of the generated cluster group data as an optimal process.

9. The process data processing device of claim 8, wherein when generating the cluster group data, the operation unit generates a plurality of items of cluster group data and selects the number of clusters in the plurality of items of cluster group data.

10. The process data processing device of claim 9, wherein when selecting the number of clusters of the plurality of items of cluster group data, the operation unit performs the selection using any one of a silhouette method, an elbow method, or a prior information classification method.

11. The process data processing device of claim 8, wherein the operation unit extracts the optimal process using any one of a K-Means model, a Gaussian Mixture Model (GMM), and an Agglomerative Hierarchical Clustering model.

12. The process data processing device of claim 1, wherein the upper threshold and the lower threshold of the process data are set by applying an upper/lower ratio or an upper/lower deviation to one item of process data associated with the optimal process, or to an average value of a plurality of items of process data extracted as optimal processes, or are set as an average of maximum values and an average of minimum values of the plurality of items of process data extracted as optimal processes.

13. A process processing method comprising:
a process data recording step in which a process data recording unit that, in conjunction with the sensor unit, receives physical magnitude values with respect to time every time a process schedule is performed, records the received physical magnitude values with respect to time as process data, and accumulatively records the process data for each process schedule;
an operation step in which an operation unit that selects at least any one item of optimal process data from the process data by a preset optimal process selection operation, and sets preset range value for the selected optimal process data as an upper threshold and a lower threshold of the process data; and
a threshold monitoring step in which a threshold monitoring unit generates a warning alarm when a physical magnitude value with respect to time detected by the sensor unit deviates from the upper threshold and the lower threshold.

14. The process processing method of claim 12, wherein, in the operation step, the upper threshold and the lower threshold include, in terms of classification based on variations in the physical magnitude value with respect to time, a large-variation upper/lower range 7b in which the physical magnitude value with respect to time varies greatly due to a sudden change such as pulse or noise.

15. The process processing method of claim 12, wherein, in the operation step, when performing the optimal process selection operation, the operation unit performs an operation on the process data each of segments.

16. The process processing method of claim 13, wherein, in the operation step, when the operation unit performs the optimal process selection operation, the segments are classified on the basis of whether differentiated data generated by differentiating the process data exceeds a preset reference value or does not exceed the preset reference value.

17. The process processing method of claim 15, wherein, in the operation step, when performing the optimal process selection operation, the operation unit extracts feature information performing time-series processing on the process data for each of the segments.

18. The process processing method of claim 17, wherein the feature information is extracted for each of the segments, including a start time, an end time, a duration, a start value, an end value, a minimum value, and a maximum value.

19. The process processing method of claim 18, wherein the feature information is extracted for each of the segments, further including at least any one of a range, a mean, an autocorrelation, a standard deviation, a slope, a coefficient of determination, a kurtosis, a concavity, a convexity, a skewness, and a crossing ratio.

20. The process processing method of claim 17, wherein, in the operation step, when performing the optimal process selection operation, the operation unit generates cluster group data by clustering the feature information of the process data, and extracts at least any one cluster within a predetermined range from a cluster center of the generated cluster group data as an optimal process.

21. The process processing method of claim 20, wherein, in the operation step, when generating the cluster group data, the operation unit generates a plurality of items of cluster group data and selects the number of clusters in the plurality of items of cluster group data.

22. The process processing method of claim 21, wherein, in the operation step, when selecting the number of clusters of the plurality of items of cluster group data, the operation unit performs the selection using any one of a silhouette method, an elbow method, or a prior information classification method.

23. The process processing method of claim 21, wherein, in the operation step, the operation unit extracts the optimal process using any one of a K-Means model, a Gaussian Mixture Model (GMM), and an Agglomerative Hierarchical Clustering model.

24. The process processing method of claim 13, wherein, in the operation step, when the upper threshold and the lower threshold of the process data are set, the upper threshold and the lower threshold of the process data are set by applying an upper/lower ratio or an upper/lower deviation to one item of process data associated with the optimal process, or to an average value of a plurality of items of process data extracted as optimal processes, or are set as an average of maximum values and an average of minimum values of the plurality of items of process data extracted as optimal processes.
